(19) United States
(12) Patent Application Publication
(10) Pub. No.: US 2026/0104778 A1
(43) Pub. Date: Apr. 16, 2026

(54) INTERACTIVE SYSTEM AND INPUT AREA SETTING METHOD

(71) Applicant: SEIKO EPSON CORPORATION, Tokyo (JP)

(72) Inventor: Shinnosuke ARAKI, MATSUMOTO-SHI (JP)

(21) Appl. No.: 19/353,793

(22) Filed: Oct. 9, 2025

(30) Foreign Application Priority Data
Oct. 11, 2024 (JP) 2024-178685

(51) Int. Cl. G06F 3/046; G06F 3/0354; G06F 3/038; G06F 3/041

(52) U.S. Cl. CPC G06F 3/046; G06F 3/03545; G06F 3/0383; G06F 3/0416

(57) ABSTRACT

An interactive system includes a display device that displays an image, a pointer that transmits an electromagnetic wave, a first sensor that receives the electromagnetic wave, a second sensor that receives the electromagnetic wave, and one or more processors, wherein the one or more processors execute calculating a first distance as a distance between the pointer and the first sensor based on output from the first sensor, calculating a second distance as a distance between the pointer and the second sensor based on output from the second sensor, calculating a position of the pointer based on the first distance, the second distance, and a positional relationship between the first sensor and the second sensor, and causing the display device to display an image based on the position of the pointer.

The present application is based on, and claims priority from JP Application Serial Number 2024-178685, filed October 11, 2024, the disclosure of which is hereby incorporated by reference herein in its entirety.

### BACKGROUND

### Technical Field

The present disclosure relates to an interactive system and an input area setting method.

### Related Art

JP-A-2007-188511 discloses a projector including a light receiver that detects a light output from an object, two sound wave receivers that receive sound waves output from the object, a distance acquirer that acquires a distance to a projection surface, and a distance calculator that calculates a position of the object based on output from these elements.

JP-A-2007-188511 is an example of the related art.

In the technique described in JP-A-2007-188511, since an ultrasonic wave is used for detection of the position of an object such as an electronic pen, the object is affected by ultrasonic noise contained in the environment.

### SUMMARY

An interactive system according to an aspect of the present disclosure includes a display device that displays an image, a pointer that transmits an electromagnetic wave, a first sensor that receives the electromagnetic wave, a second sensor that receives the electromagnetic wave, and one or more processors, wherein the one or more processors execute calculating a first distance as a distance between the pointer and the first sensor based on output from the first sensor, calculating a second distance as a distance between the pointer and the second sensor based on output from the second sensor, calculating a position of the pointer based on the first distance, the second distance, and a positional relationship between the first sensor and the second sensor, and causing the display device to display an image based on the position of the pointer.

An interactive system according to an aspect of the present disclosure includes a pointer that transmits an electromagnetic wave, a first sensor that receives the electromagnetic wave, a second sensor that receives the electromagnetic wave, and one or more processors, wherein the one or more processors execute calculating a first distance as a distance between the pointer and the first sensor based on output from the first sensor, calculating a second distance as a distance between the pointer and the second sensor based on output from the second sensor, calculating a position of the pointer based on the first distance, the second distance, and a positional relationship between the first sensor and the second sensor, receiving a first operation of designating three or more positions with the pointer, and setting an input area as an area where processing corresponding to the position of the pointer is executed by the one or more processors based on the designated three or more positions.

A position detection method according to an aspect of the present disclosure is a position detection method executed by one or more processors, including calculating a first distance as a distance between a pointer and a first sensor that receives an electromagnetic wave from the pointer based on output from the first sensor, calculating a second distance as a distance between the pointer and a second sensor that receives the electromagnetic wave from the pointer based on output from the second sensor, and calculating a position of the pointer based on the first distance, the second distance, and a positional relationship between the first sensor and the second sensor.

An input area setting method according to an aspect of the present disclosure is an input area setting method executed by one or more processors, including calculating a first distance as a distance between a pointer and a first sensor that receives an electromagnetic wave from the pointer based on output from the first sensor, calculating a second distance as a distance between the pointer and a second sensor that receives the electromagnetic wave from the pointer based on output from the second sensor, calculating a position of the pointer based on the first distance, the second distance, and a positional relationship between the first sensor and the second sensor, receiving a first operation of designating three or more positions with the pointer, and setting an input area as an area where processing corresponding to the position of the pointer is executed by the one or more processors based on the designated three or more positions.

### BRIEF DESCRIPTION OF THE DRAWINGS

FIG. 1 shows a usage form of an interactive system of an embodiment.

FIG. 2 is a block diagram showing configurations of a projector, a communication device, and an electronic pen.

FIG. 3 shows a configuration of an optical device in the projector.

FIG. 4 is a flowchart showing pen position calculation processing executed by a first processor.

FIG. 5 is a flowchart showing input area setting processing executed by the first processor.

FIG. 6 shows an example in which a first image containing four marks arranged at different positions from one another is displayed on a projection surface.

FIG. 7 is a flowchart showing object display processing executed by the first processor.

FIG. 8 shows an example of a second image.

FIG. 9 shows an example of the second image in which an object is displayed in a display area.

### DESCRIPTION OF EMBODIMENTS

Embodiments of the present disclosure will be described below with reference to the drawings. In the drawings described below, the scale of each member may be different from the actual scale in order to show each member in a recognizable size.

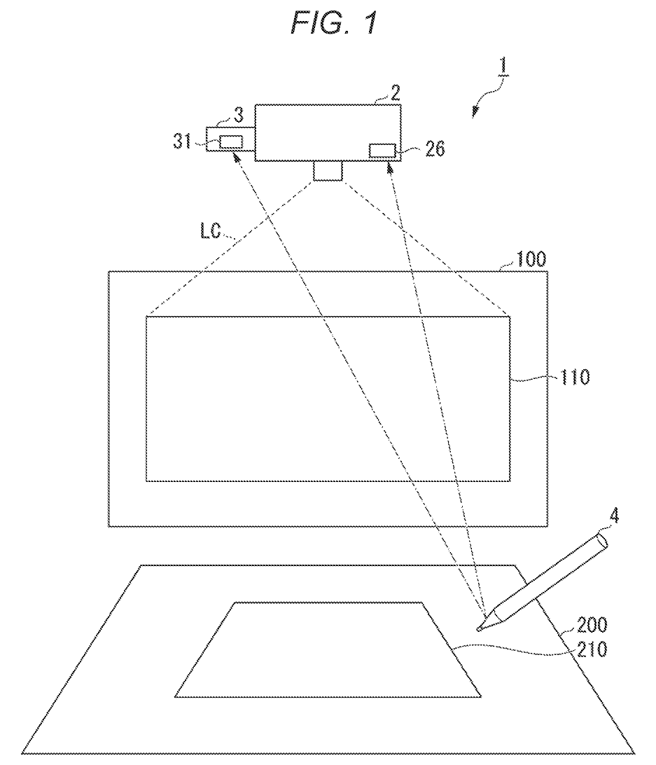

FIG. 1 shows a usage form of an interactive system 1 of the present embodiment. As shown in FIG. 1, the interactive system 1 includes a projector 2, a communication device 3, and an electronic pen 4.

The projector 2 displays an image 110 on a projection surface 100 by projecting an image light LC on the projection surface 100 based on a video signal. The projection surface 100 may be a dedicated projection screen, a wall surface, or the like. The projector 2 includes a first wireless module 26 for wireless communication with an external device. For example, the first wireless module 26 wirelessly communicates with the electronic pen 4 according to a near field communication standard such as Bluetooth (registered trademark). The projector 2 is an example of a display device.

The communication device 3 controls communication with a network. As an example, the communication device 3 is a dongle device on which a wireless module is mounted. For example, the communication device 3 is coupled to an HDMI (High-D definition Multimedia Interface: registered trademark) port of the projector 2. The communication device 3 includes a second wireless module 31 for communicating with a network. For example, the second wireless module 31 accesses the Internet via a wireless LAN (Local Area Network) that supports a wireless communication standard such as Wi-Fi (registered trademark), and receives a video signal from a video distribution server on the Internet. The communication device 3 transmits the video signal received from the video distribution server via the second wireless module 31 to the projector 2. Further, for example, the second wireless module 31 wirelessly communicates with the electronic pen 4 according to a near field communication standard such as Bluetooth (registered trademark).

The electronic pen 4 is a pointing device used by a user to operate a GUI (Graphical User Interface) displayed on the projection surface 100 or to draw an object on an electronic whiteboard displayed on the projection surface 100. Although not illustrated in FIG. 1, the electronic pen 4 includes a third wireless module 41. For example, the third wireless module 41 wirelessly communicates with the projector 2 and the communication device 3 according to a near field communication standard such as Bluetooth (registered trademark). That is, the electronic pen 4 transmits a radio wave when wirelessly communicating with the projector 2 and the communication device 3. The electronic pen 4 is an example of a pointer, and the radio wave is an example of an electromagnetic wave.

The first wireless module 26 and the second wireless module 31 receive a radio wave transmitted from the electronic pen 4 and output strength data indicating the strength of the received radio wave. As an example, the strength data is a received signal strength indicator (RSSI). The first wireless module 26 is an example of a first sensor, and the second wireless module 31 is an example of a second sensor. In the following description, the strength data output from the first wireless module 26 may be referred to as "first strength data", and the strength data output from the second wireless module 31 may be referred to as "second strength data".

Although the details will be described later, the projector 2 calculates a first distance, which is a distance between the electronic pen 4 and the first wireless module 26, based on the first strength data output from the first wireless module 26. The projector 2 calculates a second distance, which is a distance between the electronic pen 4 and the second wireless module 31, based on the second strength data output from the second wireless module 31. The projector 2 calculates the position of the electronic pen 4 relative to the first wireless module 26 and the second wireless module 31 based on the first distance, the second distance, and a positional relationship between the first wireless module 26 and the second wireless module 31. The positional relationship here includes a distance between the first wireless module 26 and the second wireless module 31, and a relative positional relationship indicating whether the first wireless module 26 is located on the right side or the left side of the second wireless module 31 when viewed from the user. Preferably, as the positional relationship, the user sets whether the first wireless module 26 is located on the right side or the left side of the second wireless module 31 when viewed from the position of the user holding the electronic pen 4. On a plane, the position of the electronic pen 4 is calculated at two points without consideration of the relative positional relationship. When the relative positional relationship between the first wireless module 26 and the second wireless module 31 is determined as one as viewed from the user, the calculated position of the electronic pen 4 is determined as one point.

The projector 2 calculates the position of the electronic pen 4 in an input area 210 set on an operation surface 200 and performs image processing based on the position of the electronic pen 4. For example, the projector 2 performs processing of displaying an object such as a figure, a character, or a symbol at a position on the whiteboard displayed on the projection surface 100 corresponding to the position of the electronic pen 4 in the input area 210. Further, for example, the projector 2 performs processing of displaying an object such as a line on the whiteboard along the trajectory of the electronic pen 4 in the input area 210.

For example, the operation surface 200 is a surface of a top plate of a desk. The operation surface 200 is not limited to the surface of the top plate of the desk, but may be a surface of another object. The operation surface 200 may be a horizontal surface or an inclined surface. The operation surface 200 may be a flat surface or a curved surface. However, in order to perform the image processing described above based on the position of the electronic pen 4, it is necessary to associate the coordinate system of the input area 210 set on the operation surface 200 with the coordinate system of the image 110 displayed on the projection surface 100. A method of setting the input area 210 will be described later.

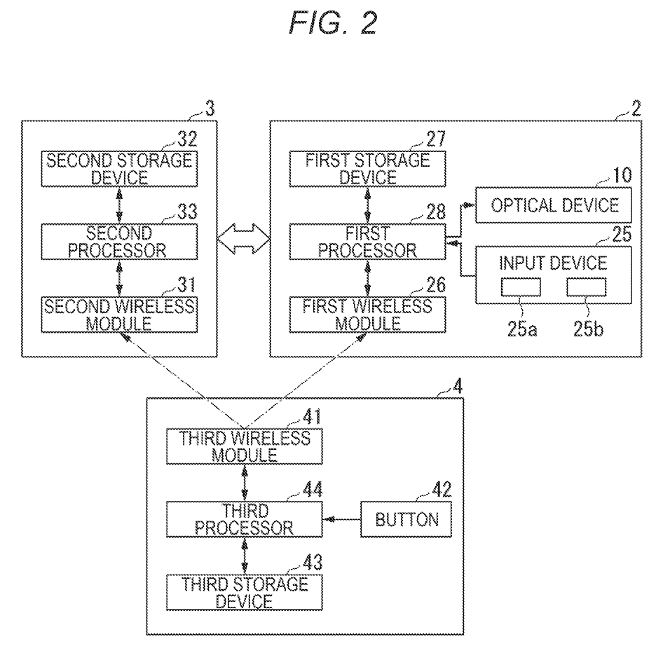

FIG. 2 is a block diagram showing configurations of the projector 2, the communication device 3, and the electronic pen 4. As shown in FIG. 2, the projector 2 includes an optical device 10, an input device 25, the first wireless module 26, a first storage device 27, and a first processor 28.

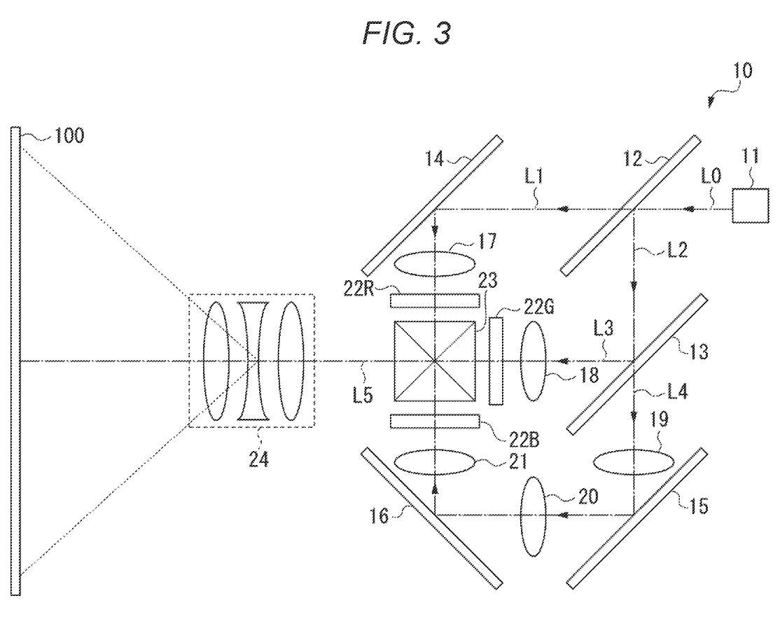

The optical device 10 generates and projects the image light LC onto the projection surface 100 under the control of the first processor 28. FIG. 3 shows an example of a configuration of the optical device 10. As illustrated in FIG. 3, the optical device 10 includes a light source 11, two dichroic mirrors 12 and 13, three reflection mirrors 14, 15, and 16, five relay lenses 17, 18, 19, 20, and 21, three liquid crystal panels 22R, 22G, and 22B, a dichroic prism 23, and a projection optical system 24.

The light source 11 emits a white light L0 to the dichroic mirror 12. The light source 11 is, for example, a halogen lamp, a mercury lamp, a light emitting diode, or a laser light source.

The dichroic mirror 12 separates the white light L0 into a first color light L1 and a second color light L2. For example, the first color light L1 is a red light, and the second color light L2 is a light of a mixed color of green and blue. The dichroic mirror 12 emits the first color light L1 to the reflection mirror 14 and emits the second color light L2 to the dichroic mirror 13.

The dichroic mirror 13 separates the second color light L2 into a third color light L3 and a fourth color light L4. For example, the third color light L3 is a green light, and the fourth color light L4 is a blue light. The dichroic mirror 13 emits the third color light L3 to the relay lens 18 and emits the fourth color light L4 to the relay lens 19.

The first color light L1 emitted from the dichroic mirror 12 enters the liquid crystal panel 22R via the reflection mirror 14 and the relay lens 17. The third color light L3 emitted from the dichroic mirror 13 enters the liquid crystal panel 22G via the relay lens 18. The fourth color light L4 emitted from the dichroic mirror 13 enters the liquid crystal panel 22B via the relay lens 19, the reflection mirror 15, the relay lens 20, the reflection mirror 16, and the relay lens 21.

The liquid crystal panels 22R, 22G, and 22B function as light modulation devices in the projector 2. For example, the liquid crystal panels 22R, 22G, and 22B are active-drive type liquid crystal panels each having a plurality of pixels arranged in a matrix. The liquid crystal panel 23R modulates the first color light L1 of red. The liquid crystal panel 23G modulates the third color light L3 of green. The liquid crystal panel 23B modulates the fourth color light L4 of blue. The first processor 28 controls the transmittance of the pixels provided in each of the liquid crystal panels 22R, 22G, and 22B based on the video signal.

The dichroic prism 23 combines the first color light L1 modulated by the liquid crystal panel 23R, the third color light L3 modulated by the liquid crystal panel 23G, and the fourth color light L4 modulated by the liquid crystal panel 23B, and thus generates an image light LC representing a color image. The dichroic prism 23 emits the image light LC to the projection optical system 24.

The projection optical system 24 includes a plurality of optical elements such as lenses, and enlarges and projects the image light LC emitted from the dichroic prism 23 toward the projection surface 100. Although not illustrated, the projection optical system 24 is provided with mechanisms that can adjust optical parameters such as a lens shift amount, a lens focus amount, and a lens zoom amount. The optical parameters of the projection optical system 24 are adjusted by the first processor 28 controlling these mechanisms.

The description will be continued by referring back to FIG. 2 below.

The input device 25 is a device that receives an operation by the user. The input device 25 includes an operation unit 25a and a light receiver 25b. The operation unit 25a includes a plurality of operation keys provided in the projector 2. For example, the operation keys include a power key, a menu call key, a direction key, an enter key, and a volume control key. The operation keys may be hardware keys or software keys displayed on a touch panel. The operation unit 25a outputs an electrical signal generated when each operation key is operated by the user to the first processor 28 as an operation signal.

The light receiver 25b includes a photoelectric conversion circuit that receives infrared light transmitted from a remote controller (not shown) of the projector 2 and converts the infrared light into an electrical signal. The light receiver 25b outputs an electric signal obtained by photoelectric conversion of the infrared light to the first processor 28 as a remote operation signal. The remote controller is provided with a plurality of operation keys similarly to the operation unit 25a. The remote controller converts an electrical signal generated when each operation key provided on the remote controller is operated by the user into infrared light and transmits the infrared light to the projector 2. That is, the remote operation signal output from the light receiver 25b is substantially the same as the electrical signal generated when each operation key of the remote controller is operated by the user.

The first wireless module 26 wirelessly communicates with the electronic pen 4 according to a near field communication standard such as Bluetooth (registered trademark) under the control of the first processor 28. The first wireless module 26 receives the radio wave transmitted from the electronic pen 4 and outputs first strength data indicating the strength of the received radio wave to the first processor 28.

The first storage device 27 includes a nonvolatile memory that stores programs necessary for causing the first processor 28 to execute various kinds of processing, various setting data, and the like, and a volatile memory used as a temporary data saving destination when the first processor 28 executes various kinds of processing. For example, the nonvolatile memory is a flash memory or the like, and the volatile memory is a RAM (Random Access Memory) or the like.

The first processor 28 is an arithmetic processing device that controls the overall operation of the projector 2 according to the program stored in the first storage device 27. As an example, the first processor 28 includes one or more processors such as a CPU (Central Processing Unit). Part or all of the functions of the first processor 28 may be implemented by a circuit such as a DSP (Digital Signal Processor), an ASIC (Application Specific Integrated Circuit), a PLD (Programmable Logic Device), or an FPGA (Field Programmable Gate Array). The first processor 28 executes various kinds of processing in parallel or sequentially.

The communication device 3 includes the second wireless module 31, a second storage device 32, and a second processor 33. As described above, the communication device 3 is coupled to the HDMI port of the projector 2. That is, the communication device 3 is communicably coupled to the projector 2.

The second wireless module 31 accesses the Internet via the wireless LAN and receives a video signal from the video distribution server on the Internet under the control of the second processor 33. The second wireless module 31 outputs the video signal received from the video distribution server to the second processor 33. The second wireless module 31 wirelessly communicates with the electronic pen 4 according to a near field communication standard such as Bluetooth (registered trademark) under the control of the second processor 33. The second wireless module 31 receives the radio wave transmitted from the electronic pen 4 and outputs second strength data indicating the strength of the received radio wave to the second processor 33.

The second storage device 32 includes a nonvolatile memory that stores programs necessary for causing the second processor 33 to execute various kinds of processing, various setting data, and the like, and a volatile memory used as a temporary data saving destination when the second processor 33 executes various kinds of processing.

The second processor 33 is an arithmetic processing device that controls the overall operation of the communication device 3 according to the program stored in the second storage device 32. As an example, the second processor 33 includes one or more processors such as a CPU. Part or all of the functions of the second processor 33 may include a circuit such as a DSP, an ASIC, a PLD, or an FPGA. The second processor 33 executes various kinds of processing in parallel or sequentially. The second processor 33 can communicate with the first processor 28 of the projector 2.

The electronic pen 4 includes the third wireless module 41, a button 42, a third storage device 43, and a third processor 44.

The third wireless module 41 wirelessly communicates with the first wireless module 26 of the projector 2 and the second wireless module 31 of the communication device 3 according to a near field communication standard such as Bluetooth (registered trademark) under the control of the third processor 44. That is, the electronic pen 4 transmits a radio wave when wirelessly communicating with the first wireless module 26 of the projector 2 and the second wireless module 31 of the communication device 3.

The button 42 outputs a signal indicating whether the user is performing an input operation using the electronic pen 4 to the third processor 44. For example, when the button 42 is pressed, that is, when the user performs an input operation using the electronic pen 4, the button 42 outputs a first signal having a first level to the third processor 44. On the other hand, when the button 42 is not pressed, that is, when the user does not perform the input operation using the electronic pen 4, the button 42 outputs the second signal having a second level to the third processor 44. One of the first level and the second level is a high level, and the other is a low level.

The third storage device 43 includes a nonvolatile memory that stores programs necessary for causing the third processor 44 to execute various kinds of processing, various setting data, and the like, and a volatile memory used as a temporary data saving destination when the third processor 44 executes various kinds of processing.

The third processor 44 is an arithmetic processing device that controls the overall operation of the electronic pen 4 according to a program stored in the third storage device 43. As an example, the third processor 44 includes one or more processors such as a CPU. Part or all of the functions of the third processor 44 may include a circuit such as a DSP, an ASIC, a PLD, or an FPGA. The third processor 44 executes various kinds of processing in parallel or sequentially.

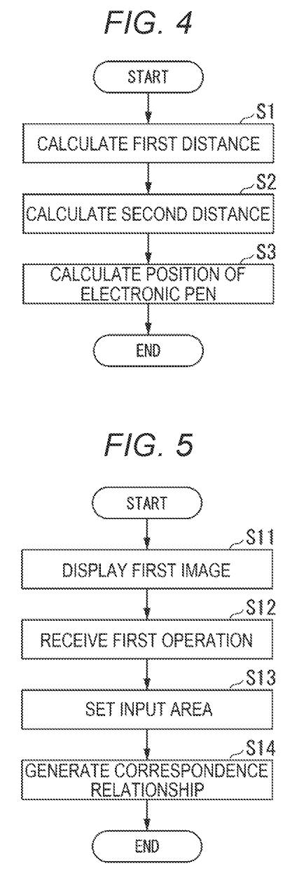

FIG. 4 is a flowchart showing pen position calculation processing executed by the first processor 28 when the first processor 28 of the projector 2 calculates the position of the electronic pen 4. The first processor 28 executes the pen position calculation processing shown in FIG. 4 by executing the program stored in the first storage device 27.

When receiving the first signal from the button 42, the third processor 44 of the electronic pen 4 controls the third wireless module 41 to transmit the radio wave containing first information indicating that the user is performing the input operation using the electronic pen 4 to the first wireless module 26 of the projector 2 and the second wireless module 31 of the communication device 3. The first wireless module 26 of the projector 2 outputs first strength data indicating the strength of the radio wave received from the electronic pen 4 and the first information contained in the radio wave received from the electronic pen 4 to the first processor 28. When acquiring the first information from the first wireless module 26, the first processor 28 recognizes that the user is performing an input operation using the electronic pen 4 and executes the pen position calculation processing.

As illustrated in FIG. 4, when starting the pen position calculation processing, the first processor 28 first calculates the first distance as the distance between the electronic pen 4 and the first wireless module 26 based on the first strength data output from the first wireless module 26 (step S1). Since a method of calculating the distance between two points from the received radio wave strength is generally known, the description thereof is omitted in the present specification.

Subsequently, the first processor 28 calculates the second distance as the distance between the electronic pen 4 and the second wireless module 31 based on the second strength data output from the second wireless module 31 (step S2). When receiving the radio wave containing the first information from the electronic pen 4, the second wireless module 31 of the communication device 3 outputs the second strength data indicating the strength of the received radio wave and the first information contained in the radio wave received from the electronic pen 4 to the second processor 33. When acquiring the first information from the second wireless module 31, the second processor 33 transmits the second strength data to the first processor 28 of the projector 2. As a result, when the first processor 28 executes step S2, the first processor 28 has the second strength data output from the second wireless module 31.

Subsequently, the first processor 28 calculates the position of the electronic pen 4 relative to the first wireless module 26 and the second wireless module 31 based on the first distance, the second distance, and the positional relationship between the first wireless module 26 and the second wireless module 31 (step S3). The positional relationship between the first wireless module 26 and the second wireless module 31 is known and is stored in the first storage device 27 in advance.

FIG. 5 is a flowchart showing input area setting processing executed by the first processor 28 when the first processor 28 of the projector 2 sets the input area 210. The first processor 28 executes the input area setting processing shown in FIG. 5 by executing the program stored in the first storage device 27.

For example, the first processor 28 executes the input area setting processing when detecting that an operation for requesting the setting of the input area 210 is received based on the output from the input device 25.

As shown in FIG. 5, when starting the input area setting processing, the first processor 28 first causes the projector 2 to display a first image 120 containing three or more marks disposed at different positions from one another as the image 110 (step S11). In other words, in step S11, the first processor 28 controls the liquid crystal panels 22R, 22G, and 22B of the optical device 10 so that the first image 120 containing three or more marks disposed at different positions from one another is displayed on the projection surface 100 as the image 110.

Subsequently, the first processor 28 receives a first operation of designating three or more positions corresponding to the three or more marks on a one-on-one basis with the electronic pen 4 (step S12). Subsequently, the first processor 28 sets the input area 210, which is an area where the processing of calculating the position of the electronic pen 4 is executed by the first processor 28, based on the designated three or more positions (step S13).

Then, the first processor 28 generates a correspondence relationship that associates the coordinate system of the input area 210 with the coordinate system of the image 110 displayed on the projection surface 100 (step S14). For example, the correspondence relationship that associates the coordinate system of the input area 210 with the coordinate system of the image 110 displayed on the projection surface 100 is coordinate conversion data for converting the coordinates of a certain point contained in the input area 210 into the coordinates of a certain point contained in the image 110.

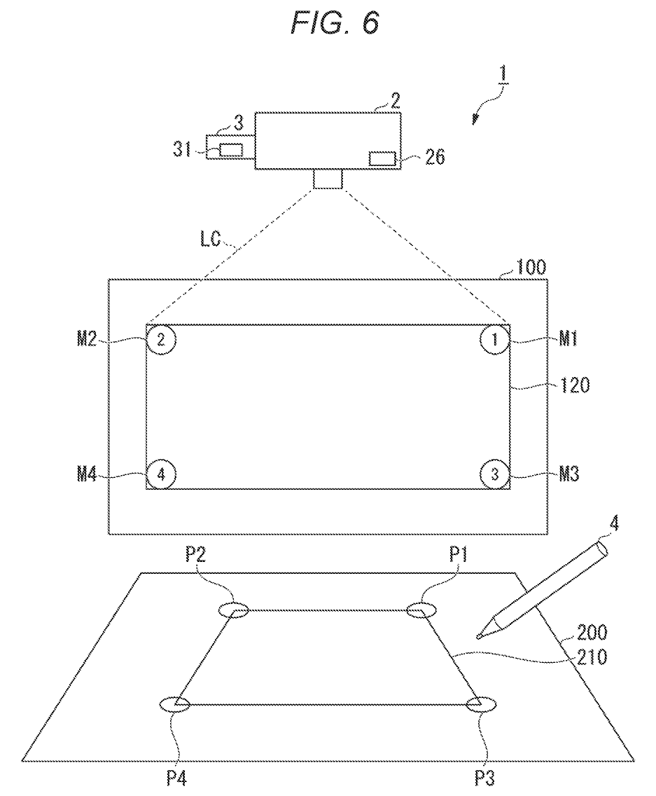

Hereinafter, the input area setting processing will be specifically described with reference to FIG. 6.

FIG. 6 shows an example in which the first image 120 containing four marks disposed at different positions from one another is displayed on the projection surface 100. As shown in FIG. 6, a first mark M1 is disposed in the upper right corner of the first image 120. A second mark M2 is disposed in the upper left corner of the first image 120. A third mark M3 is disposed in the lower right corner of the first image 120. A fourth mark M4 is disposed in the lower left corner of the first image 120.

For example, the first mark M1 is a mark containing a number "1". The second mark M2 is a mark containing a number "2". The third mark M3 is a mark containing a number "3". The fourth mark M4 is a mark containing a number "4".

For example, in a state in which the first image 120 containing the four marks as described above is displayed, the first processor 28 controls the liquid crystal panels 22R, 22G, and 22B of the optical device 10 so that a message "TO START SETTING OF INPUT AREA, FIRST, POINT POSITION CORRESPONDING TO FIRST MARK WITH ELECTRONIC PEN" is displayed in the first image 120.

The user who sees the message moves the electronic pen 4 to a first position P1 as a position corresponding to the first mark M1 on the operation surface 200. The user can determine any position on the operation surface 200 as the first position P1. The user presses the button 42 of the electronic pen 4 while holding the position of the electronic pen 4 at the first position P1. As a result, the first signal is output from the button 42.

As described above, when receiving the first signal from the button 42, the third processor 44 of the electronic pen 4 controls the third wireless module 41 to transmit the radio wave containing the first information indicating that the user is performing the input operation using the electronic pen 4 to the first wireless module 26 of the projector 2 and the second wireless module 31 of the communication device 3. In this case, the first processor 28 of the projector 2 calculates the position of the electronic pen 4 by executing the pen position calculation processing described above, and acquires the calculated position of the electronic pen 4 as the first position P1 corresponding to the first mark M1.

After acquiring the first position P1 corresponding to the first mark M1, the first processor 28 controls the liquid crystal panels 22R, 22G, and 22B of the optical device 10 so that a message "NEXT, POINT POSITION CORRESPONDING TO SECOND MARK WITH ELECTRONIC PEN" is displayed in the first image 120.

The user who sees the message moves the electronic pen 4 to a second position P2 as a position corresponding to the second mark M2 on the operation surface 200. The user can determine any position on the operation surface 200 as the second position P2. The user presses the button 42 of the electronic pen 4 while holding the position of the electronic pen 4 at the second position P2. As a result, the first signal is output from the button 42.

Similarly, when receiving the first signal from the button 42, the third processor 44 of the electronic pen 4 controls the third wireless module 41 to transmit the radio wave containing the first information indicating that the user is performing the input operation using the electronic pen 4 to the first wireless module 26 of the projector 2 and the second wireless module 31 of the communication device 3. In this case, the first processor 28 of the projector 2 calculates the position of the electronic pen 4 by executing the pen position calculation processing described above, and acquires the calculated position of the electronic pen 4 as the second position P2 corresponding to the second mark M2.

After acquiring the second position P2 corresponding to the second mark M2, the first processor 28 controls the liquid crystal panels 22R, 22G, and 22B of the optical device 10 so that a message "NEXT, POINT POSITION CORRESPONDING TO THIRD MARK WITH ELECTRONIC PEN" is displayed in the first image 120.

The user who has viewed the message moves the electronic pen 4 to a third position P3 as a position corresponding to the third mark M3 on the operation surface 200. The user can determine any position on the operation surface 200 as the third position P3. The user presses the button 42 of the electronic pen 4 while holding the position of the electronic pen 4 at the third position P3. As a result, the first signal is output from the button 42.

Similarly, when receiving the first signal from the button 42, the third processor 44 of the electronic pen 4 controls the third wireless module 41 to transmit the radio wave containing the first information indicating that the user is performing the input operation using the electronic pen 4 to the first wireless module 26 of the projector 2 and the second wireless module 31 of the communication device 3. In this case, the first processor 28 of the projector 2 calculates the position of the electronic pen 4 by executing the pen position calculation processing described above, and acquires the calculated position of the electronic pen 4 as the third position P3 corresponding to the third mark M3.

After acquiring the third position P3 corresponding to the third mark M3, the first processor 28 controls the liquid crystal panels 22R, 22G, and 22B of the optical device 10 so that a message "LAST, POINT POSITION CORRESPONDING TO FOURTH MARK WITH ELECTRONIC PEN" is displayed in the first image 120.

The user who sees the message moves the electronic pen 4 to a fourth position P4 as a position corresponding to the fourth mark M4 on the operation surface 200. The user can determine any position on the operation surface 200 as the fourth position P4. The user presses the button 42 of the electronic pen 4 while holding the position of the electronic pen 4 at the fourth position P4. As a result, the first signal is output from the button 42.

Similarly, when receiving the first signal from the button 42, the third processor 44 of the electronic pen 4 controls the third wireless module 41 to transmit the radio wave containing the first information indicating that the user is performing the input operation using the electronic pen 4 to the first wireless module 26 of the projector 2 and the second wireless module 31 of the communication device 3. In this case, the first processor 28 of the projector 2 calculates the position of the electronic pen 4 by executing the pen position calculation processing described above, and acquires the calculated position of the electronic pen 4 as the fourth position P4 corresponding to the fourth mark M4.

As described above, after receiving a first operation of designating the four positions corresponding to the four marks contained in the first image 120 on a one-on-one basis with the electronic pen 4, the first processor 28 sets an area formed by connecting the obtained four positions with straight lines as the input area 210. Then, the first processor 28 generates the coordinate conversion data as the correspondence relationship that associates the coordinate system of the input area 210 with the coordinate system of the image 110 displayed on the projection surface 100.

Here, when determining a certain position corresponding to the mark on the operation surface 200, the user presses the button 42 of the electronic pen 4 while holding the position of the electronic pen 4 at the certain position, however, the present disclosure is not limited thereto. For example, the user may determine the position corresponding to the mark by holding the electronic pen 4 at the certain position corresponding to the mark for a predetermined time.

Further, here, the area formed by connecting the four positions with straight lines is set as the input area 210, however, since a plane can be defined by determining three or more positions, for example, an area formed by connecting three or five positions with straight lines may be set as the input area 210.

After generating the coordinate conversion data, the first processor 28 controls the liquid crystal panels 22R, 22G, and 22B of the optical device 10 so that a message "SETTING OF INPUT AREA IS COMPLETED" is displayed in the first image 120. After executing the processing as described above, the first processor 28 ends the input area setting processing.

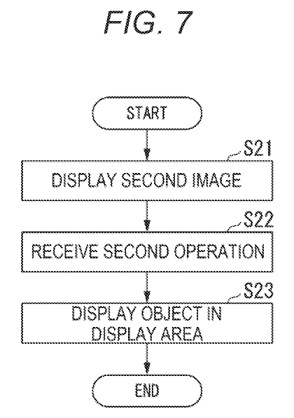

FIG. 7 is a flowchart showing object display processing executed by the first processor 28 of the projector 2. The first processor 28 executes the object display processing shown in FIG. 7 by executing the program stored in the first storage device 27.

For example, the first processor 28 executes the object display processing when detecting that an operation for requesting operation in a whiteboard mode is received based on the output from the input device 25.

As shown in FIG. 7, when starting the object display processing, the first processor 28 first causes the projector 2 to display a second image 130 containing a display area W1 for displaying an object as the image 110 (step S21). In other words, in step S21, the first processor 28 controls the liquid crystal panels 22R, 22G, and 22B of the optical device 10 so that the second image 130 containing the display area W1 for displaying the object is displayed as the image 110 on the projection surface 100. The second image 130 is an electronic white board.

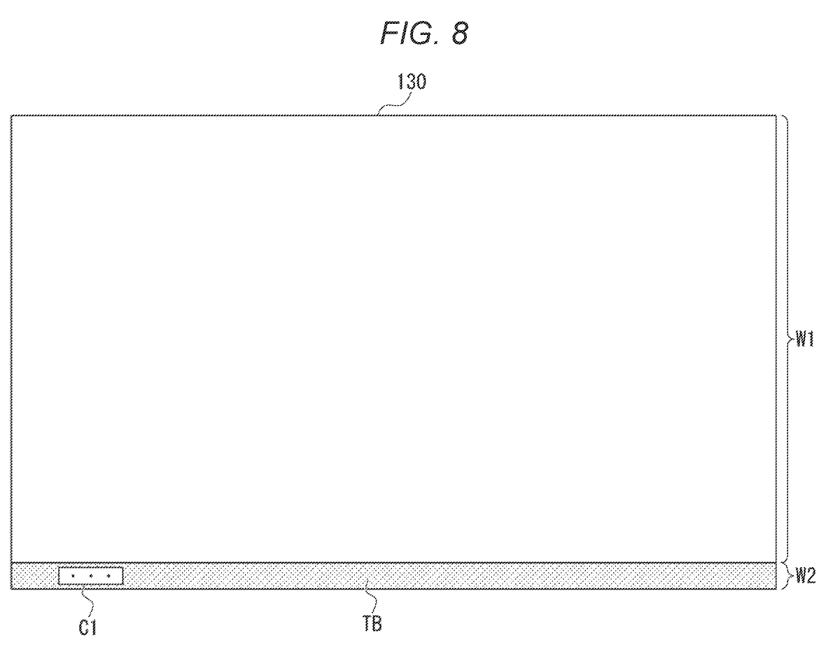

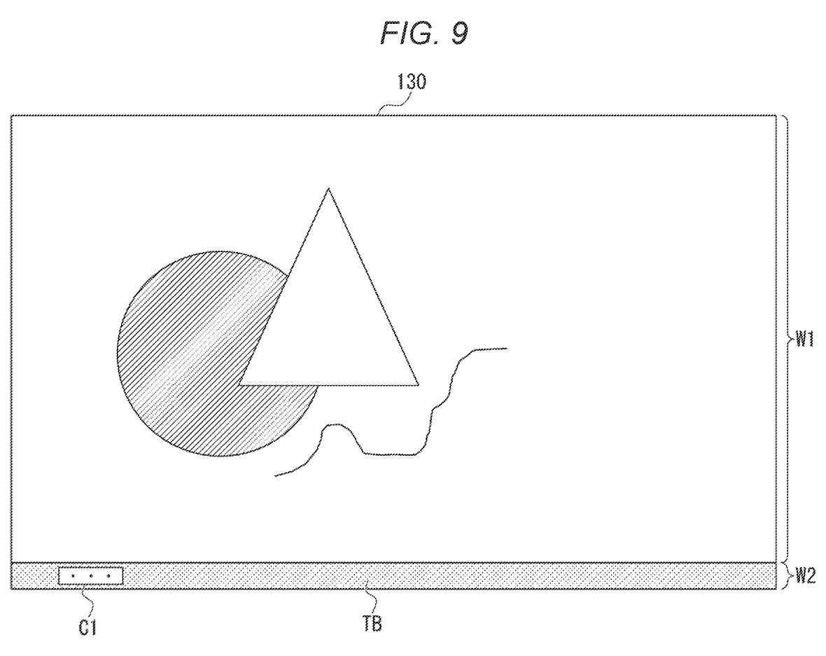

FIG. 8 shows an example of the second image 130. As shown in FIG. 8, the second image 130 includes the display area W1 as a white area and a toolbar area W2 as an area where a toolbar TB is displayed. The toolbar TB includes a menu display icon C1 as an operation icon for an instruction to display of a menu. Although not illustrated in FIG. 8, the toolbar TB includes a plurality of operation icons other than the menu display icon C1.

Returning to FIG. 7, the first processor 28 receives a second operation of drawing an object in the input area 210 by the electronic pen 4 (step S22). Then, the first processor 28 performs processing of displaying the object in the display area W1 of the second image 130 based on the second operation (step S23).

FIG. 9 shows an example of the second image 130 in which the object is displayed in the display area W1. For example, when receiving a second operation of pressing the button 42 of the electronic pen 4 with the electronic pen 4 held at a specific position in the input area 210, the first processor 28 performs processing of displaying an object such as a figure, a character, or a symbol at a position corresponding to the position of the electronic pen 4 in the input area 210 among the positions in the display area W1. Further, for example, when receiving a second operation of moving the electronic pen 4 on the input area 210 with the button 42 of the electronic pen 4 pressed, the first processor 28 performs processing of displaying an object such as a line in the display area W1 along the trajectory of the electronic pen 4 in the input area 210.

Here, the first processor 28 performs the processing when the button 42 of the electronic pen 4 is pressed, but the button 42 is not necessarily pressed when it can be determined that the electronic pen 4 is being moved on the set input area 210.

As described above, the interactive system 1 according to the present embodiment includes the projector 2 that displays the image 110, the electronic pen 4 that transmits the radio wave, the first wireless module 26 that receives the radio wave, the second wireless module 31 that receives the radio wave, and the first processor 28, and the first processor 28 executes calculating the first distance as the distance between the electronic pen 4 and the first wireless module 26 based on the output from the first wireless module 26, calculating the second distance as the distance between the electronic pen 4 and the second wireless module 31 based on the output from the second wireless module 31, calculating the position of the electronic pen 4 based on the first distance, the second distance, and the positional relationship between the first wireless module 26 and the second wireless module 31, and causing the projector 2 to display the image based on the position of the electronic pen 4.

According to the present embodiment as described above, since the radio wave is used for calculation of the position of the electronic pen 4, the interactive system 1 unaffected by ultrasonic noise contained in the environment when calculating the position of the electronic pen 4 can be provided.

In the interactive system 1 according to the present embodiment, the first processor 28 executes causing the projector 2 to display the first image 120 containing three or more marks disposed at positions different from one another as the image 110, receiving the first operation of designating three or more positions corresponding to the three or more marks on a one-on-one basis with the electronic pen 4, setting the input area 210 as the area where the processing of calculating the position of the electronic pen 4 is executed by the first processor 28 based on the designated three or more positions, and generating the correspondence relationship that associates the coordinate system of the input area 210 with the coordinate system of the image 110 displayed by the projector 2.

According to the present embodiment as described above, the user can set an area existing in any location as the input area 210 as the area where processing corresponding to the position of the electronic pen 4 is executed by the first processor 28.

In the interactive system 1 according to the present embodiment, the first processor 28 executes causing the projector 2 to display the second image 130 containing the display area W1 for displaying the object as the image 110, receiving the second operation of drawing the object in the input area 210 with the electronic pen 4, and displaying the object in the display area W1 based on the second operation.

According to the present embodiment as described above, the user can display a desired object in the display area W1 of the second image 130 by operating the electronic pen 4 in the input area 210 set at any location.

In the interactive system 1 according to the present embodiment, the input area 210 is different from the area where the image 110 is displayed by the projector 2.

According to the present embodiment as described above, the user can display a desired object in the display area W1 by operating the electronic pen 4 in the input area 210 set in a location different from the area where the image 110 is displayed by the projector 2.

The interactive system 1 according to the present embodiment further includes the communication device 3 that controls communication with the network and is coupled to the projector 2, the projector 2 includes the first wireless module 26 that outputs the first strength data indicating the strength of the radio wave received from the electronic pen 4 as the first sensor, and the communication device 3 includes the second wireless module 31 that outputs the second strength data indicating the strength of the radio wave received from the electronic pen 4 as the second sensor.

According to the present embodiment as described above, the position of the electronic pen 4 can be detected using an existing wireless module without preparing a special device for detecting the position of the electronic pen 4.

The interactive system 1 of the present embodiment includes the electronic pen 4 that transmits the radio wave, the first wireless module 26 that receives the radio wave, the second wireless module 31 that receives the radio wave, and the first processor 28, and the first processor 28 executes calculating the first distance as the distance between the electronic pen 4 and the first wireless module 26 based on the output from the first wireless module 26, calculating the second distance as the distance between the electronic pen 4 and the second wireless module 31 based on the output from the second wireless module 31, calculating the position of the electronic pen 4 based on the first distance, the second distance, and the positional relationship between the first wireless module 26 and the second wireless module 31, receiving the first operation of designating three or more positions by the electronic pen 4, and setting the input area 210 as the area where processing corresponding to the position of the electronic pen 4 is executed by the first processor 28 based on the designated three or more positions.

According to the present embodiment as described above, since the radio wave is used for calculation of the position of the electronic pen 4, the interactive system 1 unaffected by ultrasonic noise contained in the environment when calculating the position of the electronic pen 4 can be provided. Further, the user can set an area existing in any location as the input area 210 as the area where processing corresponding to the position of the electronic pen 4 is executed by the first processor 28.

A position detection method according to the present embodiment is a position detection method executed by the first processor 28, including calculating the first distance as the distance between the electronic pen 4 and the first wireless module 26 based on the output from the first wireless module 26 receiving the electromagnetic wave from the electronic pen 4, calculating the second distance as the distance between the electronic pen 4 and the second wireless module 31 based on the output from the second wireless module 31 receiving the electromagnetic wave from the electronic pen 4, and calculating the position of the electronic pen 4 based on the first distance, the second distance, and the positional relationship between the first wireless module 26 and the second wireless module 31.

According to the present embodiment as described above, since the radio wave is used for calculation of the position of the electronic pen 4, the position detection method unaffected by ultrasonic noise contained in the environment when calculating the position of the electronic pen 4 can be provided.

An input area setting method of the present embodiment is an input area setting method executed by the first processor 28, including calculating the first distance as the distance between the electronic pen 4 and the first wireless module 26 based on the output from the first wireless module 26 receiving the radio wave from the electronic pen 4, calculating the second distance as the distance between the electronic pen 4 and the second wireless module 31 based on the output from the second wireless module 31 receiving the radio wave from the electronic pen 4, calculating the position of the electronic pen 4 based on the first distance, the second distance, and the positional relationship between the first wireless module 26 and the second wireless module 31, receiving the first operation of designating three or more positions by the electronic pen 4, and setting the input area 210 as the area where processing corresponding to the position of the electronic pen 4 is executed by the first processor 28 based on the designated three or more positions.

According to the present embodiment as described above, since the radio wave is used for calculation of the position of the electronic pen 4, the input area setting method unaffected by ultrasonic noise contained in the environment when calculating the position of the electronic pen 4 can be provided. Further, the user can set an area existing in any location as the input area 210 as the area where processing corresponding to the position of the electronic pen 4 is executed by the first processor 28.

Although the embodiment of the present disclosure has been described hereinabove, the technical scope of the present disclosure is not limited to the embodiments described above, and various modifications can be made without departing from the spirit and scope of the present disclosure.

In the embodiment described above, the positional relationship between the first wireless module 26 and the second wireless module 31 is stored in the first storage device 27 in advance. The present disclosure is not limited thereto, but for example, the first processor 28 of the projector 2 may execute receiving a third operation of setting the positional relationship between the first wireless module 26 and the second wireless module 31, and calculating the position of the electronic pen 4 based on the first distance, the second distance, and the positional relationship set by the third operation. According to the modification, for example, the positional relationship between the first wireless module 26 and the second wireless module 31 can be set on the projection surface 100, and thus the user can manually set the optimum positional relationship even when the positional relationship between the first wireless module 26 and the second wireless module 31 changes.

An example of the third operation of setting the positional relationship between the first wireless module 26 and the second wireless module 31 includes projecting a user interface for the user to select a relative positional relationship indicating whether the first wireless module 26 is located on the right side or the left side of the second wireless module 31 when viewed from the user from the projector 2, and selecting either one by the user.

In the embodiment described above, the first processor 28 of the projector 2 includes one or more processors, but the present disclosure is not limited thereto. The second processor 31 of the communication device 3 or the third processor 44 of the electronic pen 4 may be one or more processors.

In the embodiment described above, the projector 2 is exemplified as an example of the display device, but the display device according to the present disclosure is not limited to the projector 2. For example, the display device according to the present disclosure may be a liquid crystal television or a liquid crystal display including a liquid crystal panel as an optical system for displaying an image. Alternatively, the display device according to the present disclosure may be a display device including an OLED (Organic Light Emitting Diode) panel as an optical system for displaying an image.

In the embodiment described above, as an example of the processing corresponding to the position of the pointer, the image based on the position of the pointer is displayed on the display device, but the present disclosure is not limited thereto. For example, a lighting device may be turned on or off, or a door may be opened or closed.

### Summary of Present Disclosure

The present disclosure will be summarized below as appendices.

(Appendix 1) An interactive system includes a display device that displays an image, a pointer that transmits an electromagnetic wave, a first sensor that receives the electromagnetic wave, a second sensor that receives the electromagnetic wave, and one or more processors, wherein the one or more processors execute calculating a first distance as a distance between the pointer and the first sensor based on output from the first sensor, calculating a second distance as a distance between the pointer and the second sensor based on output from the second sensor, calculating a position of the pointer based on the first distance, the second distance, and a positional relationship between the first sensor and the second sensor, and causing the display device to display an image based on the position of the pointer.

According to Appendix 1, since the electromagnetic wave is used for calculation of the position of the pointer, the interactive system unaffected by ultrasonic noise contained in the environment when calculating the position of the pointer can be provided.

(Appendix 2) In the interactive system according to Appendix 1, the one or more processors execute causing the display device to display a first image containing three or more marks disposed at positions different from one another as the image, receiving a first operation of designating three or more positions corresponding to the three or more marks on a one-on-one basis with the pointer, setting an input area as an area where processing of calculating the position of the pointer is executed by the one or more processors based on the designated three or more positions, and generating a correspondence relationship that associates a coordinate system of the input area with a coordinate system of the image displayed by the display device.

According to Appendix 2, the user can set an area existing in any location as the input area as the area where processing corresponding to the position of the pointer is executed by one or more processors.

(Appendix 3) In the interactive system according to Appendix 2, the one or more processors execute causing the display device to display a second image containing a display area for displaying an object as the image, receiving a second operation of drawing the object in the input area with the pointer, and displaying the object in the display area based on the second operation.

According to Appendix 3, the user can display a desired object in the display area of the second image by operating the pointer in the input area set at any location.

(Appendix 4) In the interactive system according to Appendix 2 or 3, the input area is different from an area where an image is displayed by the display device.

According to Appendix 4, the user can display a desired object in the display area by operating the pointer in the input area set at a location different from the area where the image is displayed by the display device.

(Appendix 5) The interactive system according to any one of Appendices 2 to 4, further includes a communication device that controls communication with a network and is connected to the display device, wherein the display device includes a first wireless module that outputs first strength data indicating a strength of the electromagnetic wave received from the pointer as the first sensor, and the communication device includes a second wireless module that outputs second strength data indicating a strength of the electromagnetic wave received from the pointer as the second sensor.

According to Appendix 5, the position of the pointer can be detected using an existing wireless module without preparing a special device for detecting the position of the pointer.

(Appendix 6) In the interactive system according to any one of Appendices 1 to 5, the one or more processors execute receiving a third operation of setting the positional relationship between the first sensor and the second sensor, and calculating the position of the pointer based on the first distance, the second distance, and the positional relationship set by the third operation.

According to Appendix 6, even when the positional relationship between the first sensor and the second sensor changes, the user can manually set the optimum positional relationship.

(Appendix 7) An interactive system includes a pointer that transmits an electromagnetic wave, a first sensor that receives the electromagnetic wave, a second sensor that receives the electromagnetic wave, and one or more processors, wherein the one or more processors execute calculating a first distance as a distance between the pointer and the first sensor based on output from the first sensor, calculating a second distance as a distance between the pointer and the second sensor based on output from the second sensor, calculating a position of the pointer based on the first distance, the second distance, and a positional relationship between the first sensor and the second sensor, receiving a first operation of designating three or more positions with the pointer, and setting an input area as an area where processing corresponding to the position of the pointer is executed by the one or more processors based on the designated three or more positions.

According to Appendix 7, since the electromagnetic wave is used for calculation of the position of the pointer, the interactive system unaffected by ultrasonic noise contained in the environment when calculating the position of the pointer can be provided. Further, the user can set an area existing in any location as the input area as the area where processing corresponding to the position of the pointer is executed by one or more processors.

(Appendix 8) A position detection method executed by one or more processors, includes calculating a first distance as a distance between a pointer and a first sensor that receives an electromagnetic wave from the pointer based on output from the first sensor, calculating a second distance as a distance between the pointer and a second sensor that receives the electromagnetic wave from the pointer based on output from the second sensor, and calculating a position of the pointer based on the first distance, the second distance, and a positional relationship between the first sensor and the second sensor.

According to Appendix 8, since the electromagnetic wave is used for calculation of the position of the pointer, the position detection method unaffected by ultrasonic noise contained in the environment when calculating the position of the pointer can be provided.

(Appendix 9) An input area setting method executed by one or more processors, includes calculating a first distance as a distance between a pointer and a first sensor that receives an electromagnetic wave from the pointer based on output from the first sensor, calculating a second distance as a distance between the pointer and a second sensor that receives the electromagnetic wave from the pointer based on output from the second sensor, calculating a position of the pointer based on the first distance, the second distance, and a positional relationship between the first sensor and the second sensor, receiving a first operation of designating three or more positions with the pointer, and setting an input area as an area where processing corresponding to the position of the pointer is executed by the one or more processors based on the designated three or more positions.

According to Appendix 9, since the electromagnetic wave is used for calculation of the position of the pointer, the input area setting method unaffected by ultrasonic noise contained in the environment when calculating the position of the pointer can be provided. Further, the user can set an area existing in any location as the input area as the area where processing corresponding to the position of the pointer is executed by one or more processors.

What is claimed is:

1. An interactive system comprising:
a display device that displays an image;
a pointer that transmits an electromagnetic wave;
a first sensor that receives the electromagnetic wave;
a second sensor that receives the electromagnetic wave; and
one or more processors, wherein
the one or more processors execute
calculating a first distance as a distance between the pointer and the first sensor based on output from the first sensor,
calculating a second distance as a distance between the pointer and the second sensor based on output from the second sensor,
calculating a position of the pointer based on the first distance, the second distance, and a positional relationship between the first sensor and the second sensor, and
causing the display device to display an image based on the position of the pointer.

2. The interactive system according to claim 1, wherein
the one or more processors execute:
causing the display device to display a first image containing three or more marks disposed at positions different from one another as the image;
receiving a first operation of designating three or more positions corresponding to the three or more marks on a one-on-one basis with the pointer;
setting an input area as an area where processing of calculating the position of the pointer is executed by the one or more processors based on the designated three or more positions; and
generating a correspondence relationship that associates a coordinate system of the input area with a coordinate system of the image displayed by the display device.

3. The interactive system according to claim 2, wherein
the one or more processors execute:
causing the display device to display a second image containing a display area for displaying an object as the image;
receiving a second operation of drawing the object in the input area with the pointer; and
displaying the object in the display area based on the second operation.

4. The interactive system according to claim 2, wherein
the input area is different from an area where an image is displayed by the display device.

5. The interactive system according to claim 2, further comprising a communication device that controls communication with a network and is connected to the display device, wherein
the display device includes a first wireless module that outputs first strength data indicating a strength of the electromagnetic wave received from the pointer as the first sensor, and
the communication device includes a second wireless module that outputs second strength data indicating a strength of the electromagnetic wave received from the pointer as the second sensor.

6. The interactive system according to claim 1, wherein
the one or more processors execute:
receiving a third operation of setting the positional relationship between the first sensor and the second sensor; and
calculating the position of the pointer based on the first distance, the second distance, and the positional relationship set by the third operation.

7. An interactive system comprising:
a pointer that transmits an electromagnetic wave;
a first sensor that receives the electromagnetic wave;
a second sensor that receives the electromagnetic wave; and
one or more processors, wherein
the one or more processors execute
calculating a first distance as a distance between the pointer and the first sensor based on output from the first sensor,
calculating a second distance as a distance between the pointer and the second sensor based on output from the second sensor,
calculating a position of the pointer based on the first distance, the second distance, and a positional relationship between the first sensor and the second sensor,
receiving a first operation of designating three or more positions with the pointer, and
setting an input area as an area where processing corresponding to the position of the pointer is executed by the one or more processors based on the designated three or more positions.

8. An input area setting method executed by one or more processors, comprising:
calculating a first distance as a distance between a pointer and a first sensor that receives an electromagnetic wave from the pointer based on output from the first sensor,
calculating a second distance as a distance between the pointer and a second sensor that receives the electromagnetic wave from the pointer based on output from the second sensor,
calculating a position of the pointer based on the first distance, the second distance, and a positional relationship between the first sensor and the second sensor,
receiving a first operation of designating three or more positions with the pointer, and
setting an input area as an area where processing corresponding to the position of the pointer is executed by the one or more processors based on the designated three or more positions.
